(19) United States
(12) Patent Application Publication
(10) Pub. No.: US 2014/0036414 A1
(43) Pub. Date: Feb. 6, 2014

(54) CAPACITOR

(71) Applicants: Bing-Bing Xu, SINGAPORE (SG); Ching-Ji Liang, SINGAPORE (SG); Zhao-Long Dong, SINGAPORE (SG)

(72) Inventors: Bing-Bing Xu, SINGAPORE (SG); Ching-Ji Liang, SINGAPORE (SG); Zhao-Long Dong, SINGAPORE (SG)

(73) Assignee: ASUS TECHNOLOGY PTE LTD., SINGAPORE (SG)

(21) Appl. No.: 13/939,193

(22) Filed: Jul. 11, 2013

(30) Foreign Application Priority Data
Aug. 1, 2012 (CN) 201210272488.4

(51) Int. Cl. H01G 9/15

(52) U.S. Cl. CPC H01G 9/151
USPC 361/523

(57) ABSTRACT

A capacitor includes a positive foil, an electrolyte layer, a negative foil, a plurality of positive guide needles and a plurality of negative guide needles. The electrolyte layer has a first surface and a second surface opposite to each other. The first surface overlaps the positive foil, and the second surface overlaps the negative foil. The positive guide needles are disposed at the positive foil. The negative guide needles are disposed at the negative foil. The positive foil, the electrolyte layer and the negative foil are wound to make the capacitor be a cylinder, and the positive guide needles and the negative guide needles protrude from the cylinder, respectively.

### CROSS-REFERENCE TO RELATED APPLICATION

This application claims the priority benefit of CN application serial No. 201210272488.4, filed on Aug. 1, 2012. The entirety of the above-mentioned patent application is hereby incorporated by reference herein and made a part of specification.

### BACKGROUND OF THE INVENTION

1. Field of the Invention

The invention relates to a capacitor.

2. Description of the Related Art

As electronic components develop, more precise and advanced components are applied to computers and other communicating electronic products, and a capacitor is a basic and important component.

A spiral wound aluminum electrolytic capacitor is one kind of familiar capacitors. A conventional aluminum electrolytic capacitor usually uses an etched aluminum foil with high purity as a positive foil and a negative foil. An electrolyte layer is disposed between the positive foil and the negative foil, and a positive guide needle and a negative guide needle are disposed at the positive foil and the negative foil, respectively. When the capacitor is in use, current flows through the positive guide needle, the positive foil, the electrolyte layer, the negative foil and flows out from the negative guide needle. Since current flows into the positive guide needle and is gathered at the negative guide needle to flow out, when the quantity of electric charge increases, a flowing path of the current at the positive foil and the negative foil is long, and thus an equivalent series resistance (ESR) and an equivalent series inductance (ESL) of the capacitor are relatively large.

### BRIEF SUMMARY OF THE INVENTION

A capacitor is provided. The capacitor includes a positive foil and a negative foil, a flowing path of current thereon is shortened, and thus the capacitor has a relatively low ESR and a low ESL.

A capacitor includes a positive foil, an electrolyte layer, a negative foil, a plurality of positive guide needles and a plurality of negative guide needles. The electrolyte layer includes a first surface and a second surface opposite to each other, and the first surface overlaps the positive foil. The negative foil overlaps the second surface of the electrolyte layer. The positive guide needles are disposed at the positive foil. The negative guide needles are disposed at the negative foil. The positive foil, the electrolyte layer and the negative foil are wound to make the capacitor be a cylinder, and the positive guide needles and the negative guide needles protrude from the cylinder, respectively.

A capacitor includes a positive foil, an electrolyte layer, a negative foil, a positive guide needle and a plurality of negative guide needles. The electrolyte layer includes a first surface and a second surface opposite to each other, and the first surface overlaps the positive foil. The negative foil overlaps the second surface of the electrolyte layer. The positive guide needle is disposed at the positive foil. The negative guide needles are disposed at the negative foil. The positive foil, the electrolyte layer and the negative foil are wound to make the capacitor be a cylinder, and the positive guide needles and the negative guide needles protrude from the cylinder, respectively.

A capacitor includes a positive foil, an electrolyte layer, a negative foil, a plurality of positive guide needles and a negative guide needle. The electrolyte layer includes a first surface and a second surface opposite to each other, and the first surface overlaps the positive foil. The negative foil overlaps the second surface of the electrolyte layer. The positive guide needles are disposed at the positive foil. The negative guide needle is disposed at the negative foil. The positive foil, the electrolyte layer and the negative foil are wound to make the capacitor be a cylinder, and the positive guide needles and the negative guide needles protrude from the cylinder, respectively.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a capacitor in a first embodiment;

FIG. 2 is a schematic diagram showing a capacitor in a second embodiment;

FIG. 3 is a schematic diagram showing a capacitor when it spreads out in a third embodiment;

FIG. 4A is a schematic diagram showing a capacitor in a fourth embodiment;

FIG. 4B is a side view showing the capacitor in FIG. 4A when it spreads out;

FIG. 5A is a schematic diagram showing a capacitor in a fifth embodiment;

FIG. 5B is a side view showing the capacitor in FIG. 5A when it spreads out;

FIG. 6A is a schematic diagram showing a capacitor in a sixth embodiment; and

FIG. 6B is a side view showing the capacitor in FIG. 6A when it spreads out.

### DETAILED DESCRIPTION OF THE EMBODIMENTS

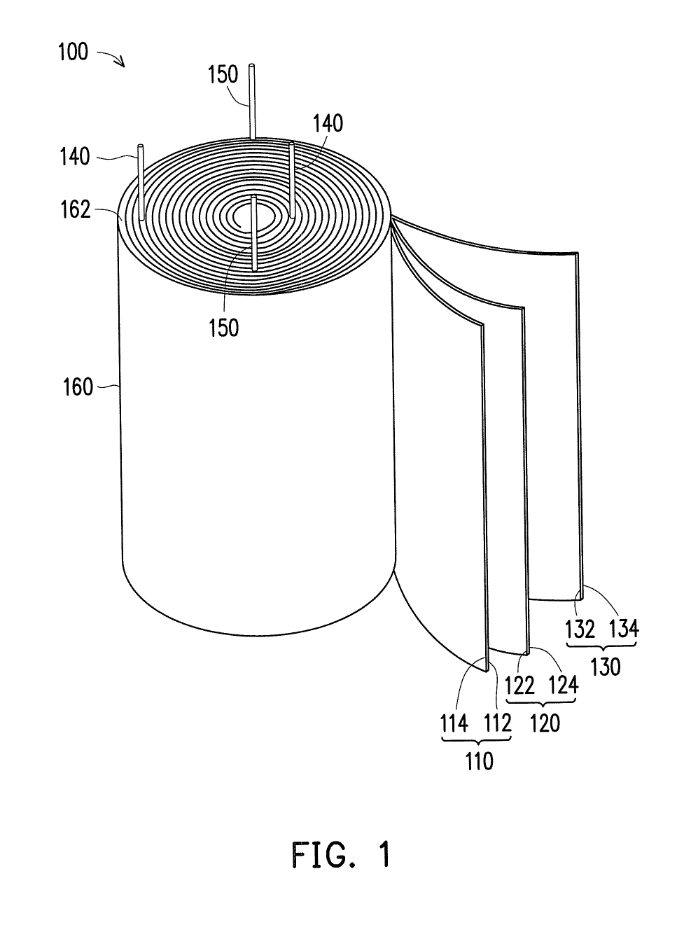

FIG. 1 is a schematic diagram showing a capacitor in a first embodiment. Please refer to FIG. 1; the capacitor 100 includes a positive foil 110, an electrolyte layer 120, a negative foil 130, a plurality of positive guide needles 140 and a plurality of negative guide needles 150.

The electrolyte layer 120 includes a first surface 122 and a second surface 124 opposite to each other, and the first surface 122 overlaps a first surface 112 of the positive foil 110. A first surface 132 of the negative foil 130 overlaps a second surface 124 of the electrolyte layer 120. The positive guide needles 140 are disposed at the positive foil 110, and the negative guide needles 150 are disposed at the negative foil 130.

The positive foil 110, the electrolyte layer 120 and the negative foil 130 are wound to make the capacitor 100 be a cylinder 160, and the positive guide needles 140 and the negative guide needles 150 protrude from the cylinder 160, respectively. In the cylinder 160, an insulating layer is between the second surface 114 of the positive foil 110 and the second surface 134 of the negative foil 130 to avoid a short between the positive foil 110 and the negative foil 130.

An electrolyte layer may be set between the second surface 114 of the positive foil 110 and the second surface 134 of the negative foil 130. In the embodiment, the capacitor 100 is a chip capacitor of surface mount type, which is not limited herein.

The positive guide needles 140 and the negative guide needles 150 protrude from a surface 162 of the cylinder 160, respectively, and the positive guide needles 140 and the negative guide needles 150 are alternately arranged.

In the embodiment, the number of the positive guide needles 140 and the negative guide needles 150 is two, respectively, which is not limited herein. The two positive guide needles 140 and the two negative guide needles 150 are disposed relatively to each other at the surface 162. As shown in FIG. 1, if the two positive guide needles 140 are disposed at positions near 0° direction and 180° direction of the surface 162 of the cylinder 160, respectively, the two negative guide needles 150 are disposed at positions near 90° direction and 270° direction of the surface 162 of the cylinder 160, respectively. Positions of the positive guide needles 140 and the negative guide needles 150 at the surface 162 of the cylinder 160 are not limited.

When the capacitor 100 is in use, the current flows through the positive guide needles 140, the positive foil 110, the electrolyte layer 120 and the negative foil 130, and then is gathered at the negative guide needles 150 to flow out. In the embodiment, the positive guide needles 140 and the negative guide needles 150 of the capacitor 100 are disposed at the positive foil 110 and the negative foil 130, respectively. When the quantity of electric charge is large, the current flows from the positive guide needles 140 to the positive foil 110, and then flows from the negative foil 130 to the near negative guide needles 150, which can shorten the current flowing path between the positive foil 110 and the negative foil 130.

Thus, due to the multiple positive guide needles 140 and the multiple negative guide needles 150 of the capacitor 100, the ESR and the ESL can be effectively reduced.

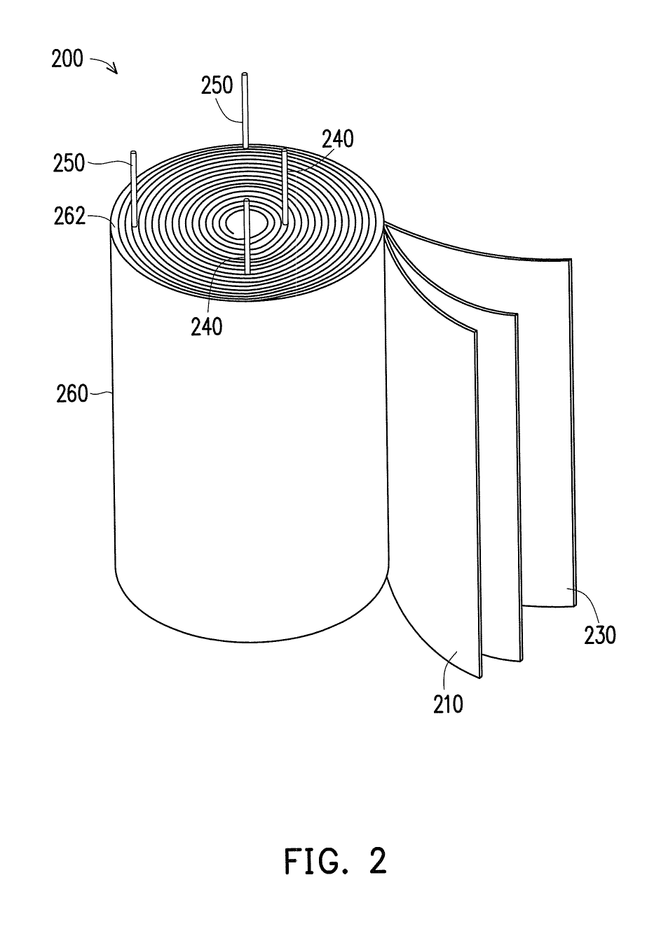

FIG. 2 is a schematic diagram showing a capacitor in a second embodiment. Please refer to FIG. 2, the difference between the capacitor 200 in FIG. 2 and the capacitor 100 in FIG. 1 is that the two positive guide needles 240 of the capacitor 200 in FIG. 2 are disposed opposite to the two negative guide needles 250 at the surface 262 of the cylinder 260. As shown in FIG. 2, one of the positive guide needles 240 is disposed at a position near 0° direction of the surface 262 of the cylinder 260, and one of the negative guide needles 250 is disposed at a position near 180° direction of the surface 262 of the cylinder 260. The other one of the negative guide needles 250 is disposed at a position near 90° direction of the surface 262 of the cylinder 260, and the other one of the positive guide needles 240 is disposed at a position near 270° direction of the surface 262 of the cylinder 260.

In the embodiment, the multiple positive guide needles 240 and the multiple negative guide needles 250 disposed at the positive foil 210 and the negative foil 230 of the capacitor 200 can shorten the current flowing path between the positive foil 210 and the negative foil 230, so as to reduce the ESR and the ESL. The positions of the positive guide needles 240 and the negative guide needles 250 at the surface 262 of the cylinder 260 are not limited herein.

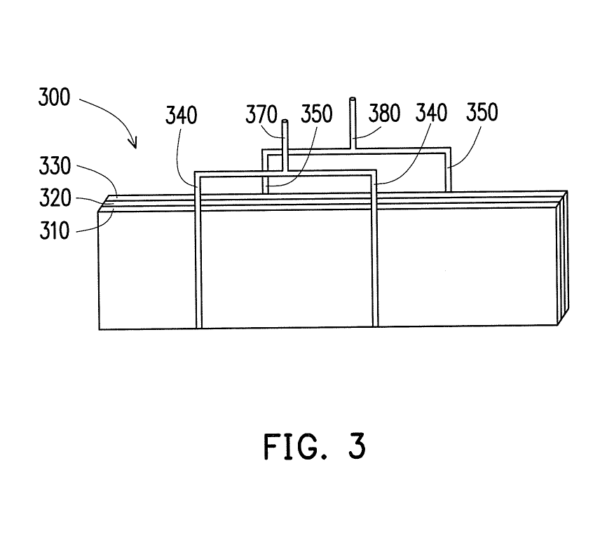

FIG. 3 is a schematic diagram showing a capacitor when it spreads out in a third embodiment. Please refer to FIG. 3, the difference between the capacitor 300 in FIG. 3 and the capacitor 100 in FIG. 1 is that the capacitor 300 in FIG. 3 further includes at least one positive terminal 370 and at least one negative terminal 380 outside the positive foil 310 and the negative foil 330.

In the embodiment, the capacitor 300 includes one positive terminal 370 and one negative terminal 380. The two positive guide needles 340 at the positive foil 310 are connected to the positive terminal 370, and the two negative guide needles 350 at the negative foil 330 are connected to the negative terminal 380. When the capacitor 300 is in use, the current flows through the positive terminal 370, the two positive guide needles 340, the positive foil 310, the electrolyte layer 320, the negative foil 330, the negative guide needles 350, and is gathered at the negative terminal 380 to flow out.

Thus, after the capacitor 300 is wound as a cylinder, its shape is similar with that of a conventional capacitor, and the current is inputted and outputted via the positive terminal 370 and the negative terminal 380. However, since the capacitor 300 includes a plurality of the positive guide needles 340 and a plurality of the negative guide needles 350 at the positive foil 310 and the negative foil 330, respectively, the current flowing path between the positive foil 310 and the negative foil 330 is shortened, and the ESR and the ESL are reduced.

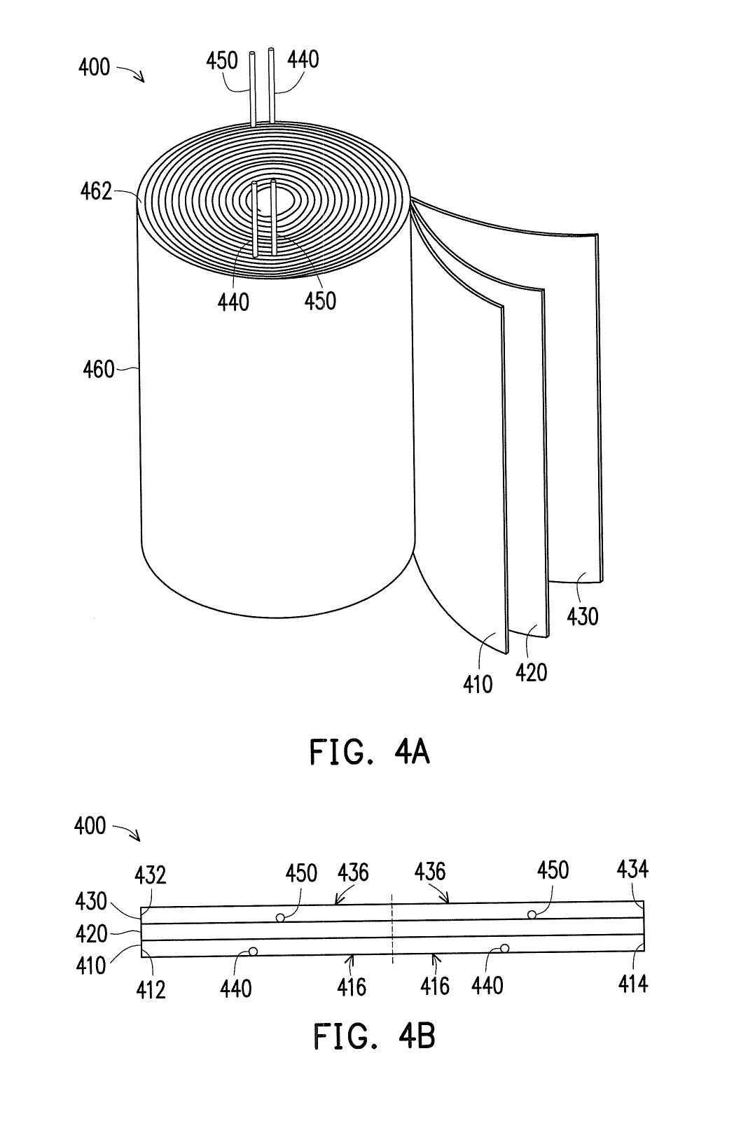

FIG. 4A is a schematic diagram showing a capacitor in a fourth embodiment, and FIG. 4B is a side view showing the capacitor in FIG. 4A when it spreads out. Please refer to FIG. 4A and FIG. 4B, the difference between the capacitor 400 of FIG. 4A and the capacitor 100 of FIG. 1 is the configuration positions of the positive guide needles 440 and the negative guide needles 450 at the positive foil 410 and the negative foil 430.

As shown in FIG. 4B, in the embodiment, the number of the positive guide needles 440 is two, and a section between a first end 412 and a second end 414 of the positive foil 410 is divided to two parts 416 corresponding to the number of the positive guide needles 440. The two positive guide needles 440 are disposed in the two parts 416 of the positive foil 410 one-to-one. The number of the negative guide needles 450 is two, and a section between a first end 432 and a second end 434 of the negative foil 430 is divided to two parts 436 corresponding to the number of the negative guide needles 450. The two negative guide needles 450 are disposed in the two parts 436 of the negative foil 430 one-to-one.

In the embodiment, the two parts 416 of the positive foil 410 have a same length, and the two parts 436 of the negative foil 430 also have a same length. That is, the positive foil 410 and the negative foil 430 are divided from the middle to form the four parts 416 and 436, respectively. The length of the parts 416 and the parts 436 may be different, which is not limited herein.

As shown in FIG. 4B, the positive guide needles 440 are disposed near the center of the parts 416 of the positive foil 410, respectively, and the negative guide needles 450 are disposed near the center of the parts 436 of the negative foil 430, respectively.

In the embodiment, the positive guide needles 440 and the negative guide needles 450 are disposed near the center of the parts 416 of the positive foil 410 and the parts 436 of the negative foil 430, respectively. Thus, the current flows through similar distance from the positive guide needles 440 to two ends of the two parts 416 of the positive foil 410, and the current flowing distances from two ends of the two parts 436 of the negative foil 430 to the negative guide needles 450 are also the same.

Compared to the conventional capacitor including a same number of the positive guide needles and the negative guide needles, the capacitor 400 has a smaller ESR and a smaller ESL. The positive guide needles 440 and the negative guide needles 450 can also be disposed at any positions of the parts of the positive foil and the negative foil, respectively, which is not limited herein.

If the configuration positions of the positive guide needles 440 and the negative guide needles 450 are overlapped, the thickness of the positive foil and the negative foil increases, which is inconvenient for packaging. Moreover, the positive guide needles 440 and the negative guide needles 450 may have a short circuit.

Thus, the configuration positions of the positive guide needles 440 and the negative guide needles 450 deviate from the center of the parts 416 and the parts 436. As shown in FIG. 4B, the positive guide needles 440 are disposed at the left side of the center of the parts 416, and the negative guide needles 450 are disposed at the right side of the center of the parts 436. Thus, when the positive foil 410, the electrolyte layer 420 and the negative foil 430 spread out, projections of the positive guide needles 440 towards the disposing surface (which is the negative foil 430) of the negative guide needles 450 are not overlapped with projections of the negative guide needles 450, so as to avoid a short circuit of the positive guide needles 440 and the negative guide needles 450.

The positive guide needles 440 and the negative guide needles 450 disposed at the positive foil 410 and the negative foil 430 of the capacitor 400 can shorten the current flowing path between the positive foil 410 and the negative foil 430. Furthermore, the positive guide needles 440 and the negative guide needles 450 of the capacitor 400 are disposed near the center of the parts 416 and the parts 436 of the positive foil 410 and the negative foil 430, respectively. Compared to the conventional capacitor including the same number of the positive guide needles and the negative guide needles, the capacitor 400 has a smaller ESR and a smaller ESL.

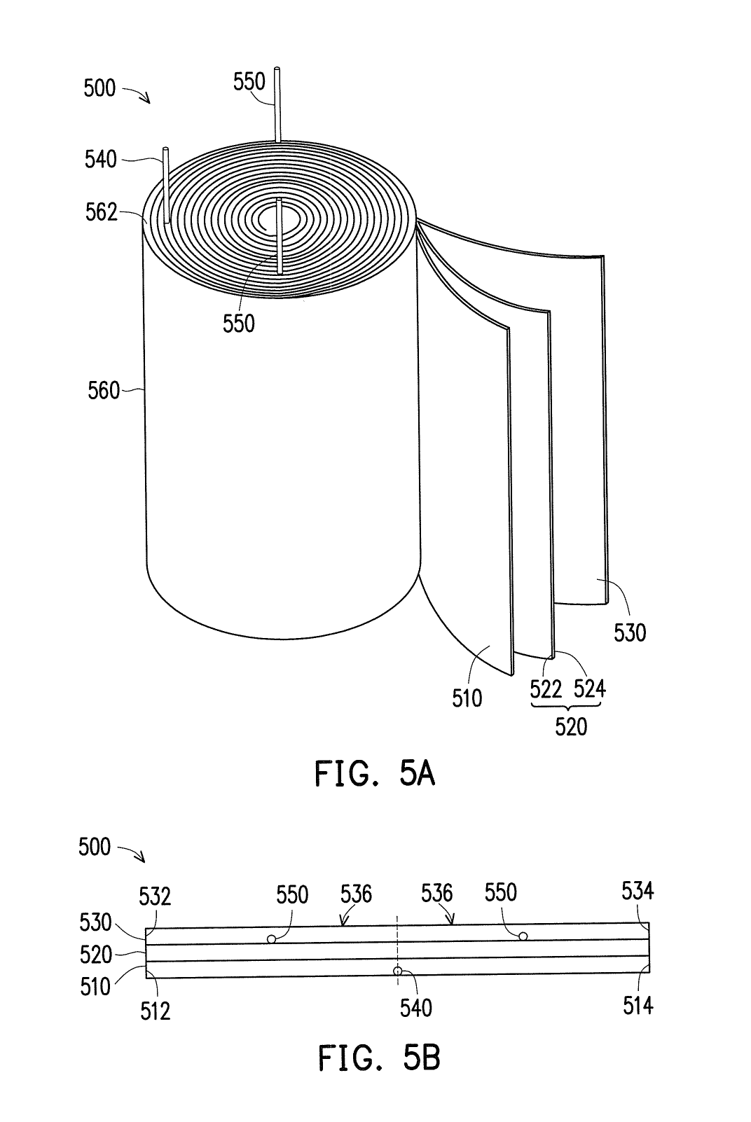

FIG. 5A is a schematic diagram showing a capacitor in a fifth embodiment. Please refer to FIG. 5A, the difference between the capacitor 500 in FIG. 5A and the capacitor 100 in FIG. 1 is that the capacitor 500 in FIG. 5A includes a positive foil 510, an electrolyte layer 520, a negative foil 530, a positive guide needle 540 and a plurality of negative guide needles 550. The electrolyte layer 520 includes a first surface 522 and a second surface 524 opposite to each other, and the first surface 522 overlaps the positive foil 510. The negative foil 530 overlaps the second surface 524 of the electrolyte layer 520. The positive guide needle 540 is disposed at the positive foil 510. The negative guide needles 550 are disposed at the negative foil 530. The positive foil 510, the electrolyte layer 520 and the negative foil 530 are wound to make the capacitor 500 be a cylinder 560, and the positive guide needle 540 and the negative guide needles 550 protrude from the cylinder 560, respectively.

Compared to the capacitor 100 including a plurality of the positive guide needles 140 in FIG. 1, the capacitor 500 in FIG. 5A only includes one positive guide needle 540. Compared to a conventional capacitor, the multiple negative guide needles 550 at the negative foil 530 of the capacitor 500 shorten the current flowing path at the negative foil 530, and reduce the ESR and the ESL of the capacitor 500.

FIG. 5B is a side view showing the capacitor in FIG. 5A when it spreads out. Please refer to FIG. 5B, the capacitor 500 only includes one positive guide needle 540, and the positive guide needle 540 is disposed at the center of the positive foil 510. The capacitor 500 includes two negative guide needles 550. A section between a first end 532 and a second end 534 of the negative foil 530 is divided to two parts 536, and the two negative guide needles 550 are disposed at the two parts 536 one-to-one. In the embodiment, the two parts 536 of the negative foil 530 have a same length, and the negative guide needles 550 are disposed at the center of the two parts 536, respectively.

The positive guide needle 540 is disposed at the center of the positive foil 510, and the negative guide needles 550 are disposed at the center of the two parts 536 of the negative foil 530, respectively. Thus, the distances from the positive guide needle 540 to a first end 512 and a second end 514 of the positive foil 510 are the same when the current flows in the positive foil 510, and the current flows through a same distance from two ends of the two parts 536 of the negative foil 530 to the negative guide needles 550. Compared to a capacitor including a same number of the positive guide needle and the negative guide needles, the capacitor 500 has a smaller ESR and a smaller ESL. The configuration positions of the positive guide needle 540 and the negative guide needles 550 at the positive foil 510 and the negative foil 530 are not limited.

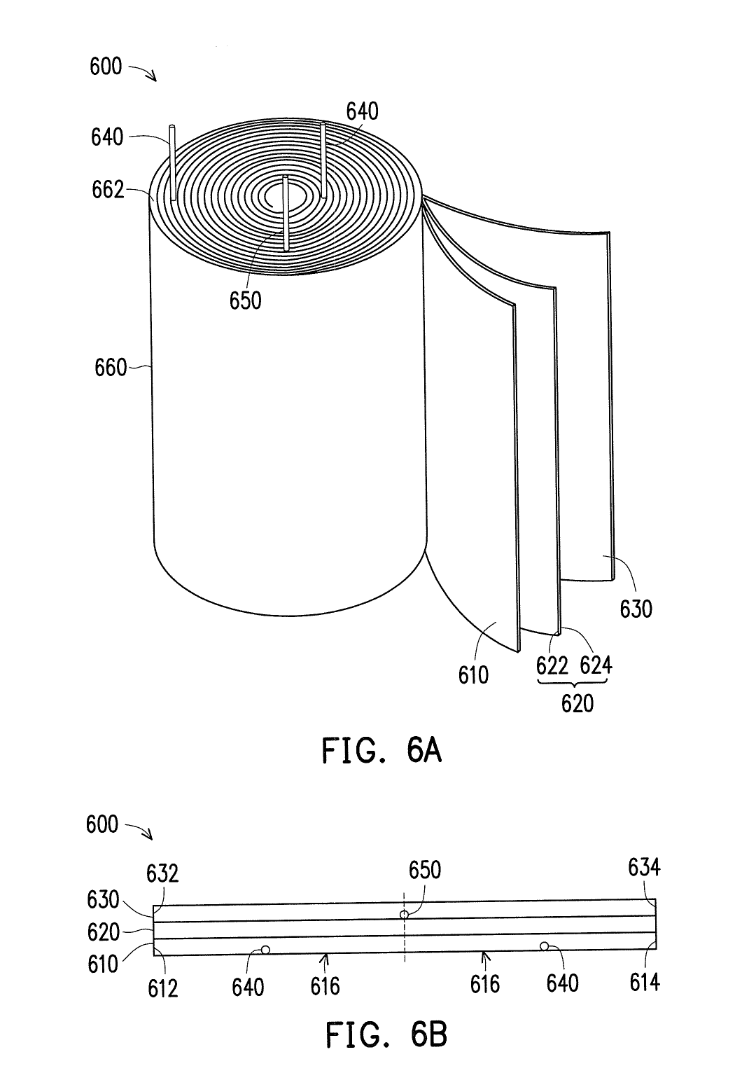

FIG. 6A is a schematic diagram showing a capacitor in a sixth embodiment. Please refer to FIG. 6A, the difference between the capacitor 600 in FIG. 6A and the capacitor 100 in FIG. 1 is that the capacitor 600 in FIG. 6A includes a positive foil 610, an electrolyte layer 620, a negative foil 630, a plurality of positive guide needles 640 and a negative guide needle 650. The electrolyte layer 620 includes a first surface 622 and a second surface 624 opposite to each other, and the first surface 622 overlaps the positive foil 610. The negative foil 630 overlaps the second surface 624 of the electrolyte layer 620. The positive guide needles 640 are disposed at the positive foil 610. The negative guide needle 650 is disposed at the negative foil 630. The positive foil 610, the electrolyte layer 620 and the negative foil 630 are wound to make the capacitor 600 be a cylinder 660, and the positive guide needles 640 and the negative guide needle 650 protrude from the cylinder 660, respectively.

Compared to the capacitor 100 including a plurality of the negative guide needles 150 in FIG. 1, the capacitor 600 in FIG. 6A only includes one negative guide needle 650. Compared to a conventional capacitor, the multiple positive guide needles 640 at the positive foil 610 of the capacitor 600 shorten the current flowing path at the positive foil 610, and reduce the ESR and the ESL of the capacitor 600.

FIG. 6B is a side view showing the capacitor in FIG. 6A when it spreads out. Please refer to FIG. 6B, the capacitor 600 includes two positive guide needles 640. A section between a first end 612 and a second end 614 of the positive foil 610 is divided to two parts 616, and the two positive guide needles 640 are disposed in the two parts 616 of the positive foil 610 one-to-one. In the embodiment, the two parts 616 of the positive foil 610 have a same length, and the positive guide needles 640 are disposed at the center of the two parts 616, respectively. Moreover, the capacitor 600 only includes one negative guide needle 650, and the negative guide needle 650 is disposed at the center of the negative foil 630.

The positive guide needles 640 are disposed at the center of the two parts 616 of the positive foil 610, respectively, and the negative guide needle 650 is disposed at the center of the negative foil 630. Thus, the current flows through a same distance from the positive guide needles 640 to two ends of the two parts 616 of the positive foil 610, and the distances from a first end 632 and a second end 634 of the negative foil 630 to the negative guide needle 650 are the same when the current flows in the negative foil 630. Compared to a capacitor including a same number of the positive guide needles and the negative guide needle, the capacitor 600 has a smaller ESR and a smaller ESL. The configuration positions of the positive guide needles 640 and the negative guide needle 650 at the positive foil 610 and the negative foil 630 are not limited.

In sum, the capacitor includes a plurality of positive guide needles or a plurality of negative guide needles at the positive foil and the negative foil, which effectively shortens the current flowing path between the positive foil and the negative foil. Thus, the ESR and the ESL of the capacitor can be reduced. Furthermore, the positive foil and the negative foil of the capacitor are divided to parts corresponding to the number of the positive guide needles and the negative guide needles, and the positive guide needles and the negative guide needles are disposed near the center of the parts, respectively. Thus, the current flows through a same distance from the positive guide needles to two ends of the parts of the positive foil, and the distances from two ends of the parts of the negative foil to the negative guide needles are nearly the same when the current flows in the negative foil, which can reduce the ESR and the ESL.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A capacitor, comprising:
a positive foil;
an electrolyte layer including a first surface and a second surface opposite to each other, wherein the first surface overlaps the positive foil;
a negative foil attached to the second surface of the electrolyte layer;
a plurality of positive guide needles disposed at the positive foil; and
a plurality of negative guide needles disposed at the negative foil,
wherein the positive foil, the electrolyte layer and the negative foil are wound to make the capacitor be a cylinder, and the positive guide needles and the negative guide needles protrude from the cylinder, respectively.

2. The capacitor according to claim 1, wherein when the number of the positive guide needles is n, a section between a first end and a second end of the positive foil is divided to n parts, each of the positive guide needles is disposed at one part of the positive foil, respectively, and when the number of the negative guide needles is in, a section between a first end and a second end of the negative foil is divided to in parts, and each of the negative guide needles is disposed at one part of the negative foil, respectively.

3. The capacitor according to claim 2, wherein the parts of the positive foil are in a same length and the parts of the negative foil are in a same length.

4. The capacitor according to claim 2, wherein each of the positive guide needles is disposed near a center of a corresponding part of the positive foil, respectively, and each of the negative guide needles is disposed near a center of a corresponding part of the negative foil, respectively.

5. The capacitor according to claim 1, when the positive foil, the electrolyte layer and the negative foil spread out, projections of the positive guide needles towards the disposing surface of the negative guide needles are not overlapped with projections of the negative guide needles.

6. The capacitor according to claim 1, wherein the capacitor further includes at least one positive terminal and at least one negative terminal outside the positive foil and the negative foil, respectively, the positive guide needles are connected to the positive terminal, and the negative guide needles are connected to the negative terminal.

7. The capacitor according to claim 1, wherein the positive guide needles and the negative guide needles are arranged alternately.

8. The capacitor according to claim 1, wherein the positive guide needles and the negative guide needles protrude from a surface of the cylinder, respectively, and one of the positive guide needles and one of the negative guide needles are arranged relative to each other, respectively, at the surface.

9. A capacitor, comprising:
a positive foil;
an electrolyte layer including a first surface and a second surface opposite to each other, wherein the first surface overlaps the positive foil;
a negative foil attached to the second surface of the electrolyte layer;
a positive guide needle disposed at the positive foil; and
a plurality of negative guide needles disposed at the negative foil,
wherein the positive foil, the electrolyte layer and the negative foil are wound to make the capacitor in a cylinder shape, and the positive guide needle and the negative guide needles protrude from the cylinder, respectively.

10. The capacitor according to claim 9, wherein when the number of the negative guide needles is m, a section between a first end and a second end of the negative foil is divided to m parts, and each of the negative guide needles is disposed at a corresponding part of the negative foil, respectively.

11. A capacitor, comprising:
a positive foil;
an electrolyte layer including a first surface and a second surface opposite to each other, wherein the first surface overlaps the positive foil;
a negative foil attached to the second surface of the electrolyte layer;
a plurality of positive guide needles disposed at the positive foil; and
a negative guide needle disposed at the negative foil,
wherein the positive foil, the electrolyte layer and the negative foil are wound to make the capacitor be a cylinder, and the positive guide needles and the negative guide needles protrude from the cylinder, respectively.

12. The capacitor according to claim 11, wherein when the number of the positive guide needles is n, a section between a first end and a second end of the positive foil is divided to n parts, and each of the positive guide needles is disposed at a corresponding part of the positive foil, respectively.
